(19) United States
(12) Patent Application Publication
(10) Pub. No.: US 2014/0141147 A1
(43) Pub. Date: May 22, 2014

(54) CONFECTIONERY PRODUCT COMPRISING AGGLOMERATED OIL POWDER

(71) Applicants: Daniel Johannes Dopfer, Bretigny-sur-Morre (CH); Tim Oliver Althaus, Lausanne (CH); Judith Arfsten, Villars-sur-Glane (CH); Stefan Palzer, York, Yorkshire (GB); Gerhard Niederreiter, Savigny (CH); Baltasar Valles-Pamies, Sansepolcro (IT); James William Outram, Santiago (CL)

(72) Inventors: Daniel Johannes Dopfer, Bretigny-sur-Morre (CH); Tim Oliver Althaus, Lausanne (CH); Judith Arfsten, Villars-sur-Glane (CH); Stefan Palzer, York, Yorkshire (GB); Gerhard Niederreiter, Savigny (CH); Baltasar Valles-Pamies, Sansepolcro (IT); James William Outram, Santiago (CL)

(73) Assignee: Nestec S.A., Vevey (CH)

(21) Appl. No.: 13/997,924

(22) PCT Filed: Dec. 23, 2011
(86) PCT No.: PCT/EP11/74017

§ 371 Date: Oct. 23, 2013

(30) Foreign Application Priority Data
Dec. 29, 2010 (EP) 10197254.5

(51) Int. Cl. A23G 3/40

(52) U.S. Cl. CPC A23G 3/40
USPC 426/609; 426/453

(57) ABSTRACT

The present invention relates to a solid confectionery product comprising pressure agglomerated powder ingredients, wherein said powder ingredients comprise an oil powder, the use of an oil powder for the preparation of a solid confectionery product, and processes for the preparation of a solid confectionery product compacting or shaping the ingredients including an oil powder by a pressure agglomeration process.

### FIELD OF THE INVENTION

The present invention relates to confectionary products, more particularly to the use of oil powder for the preparation of confectionery products, to solid confectionery products comprising agglomerated oil powder and to processes for the preparation thereof.

### BACKGROUND OF THE INVENTION

Confectionery products, such as bar, tablet, praline type confections are widely appreciated. However such products tend to have a nutritional profile high in total fat and high in saturated fats.

The type of fat used in such confectionery products governs the texture as well as other organoleptic properties of the product. For instance, a fat based solid confectionery product must provide a sufficiently firm texture to ensure shape stability of the product and to avoid substantial deformation of the shape of the product upon handling. It is also desirable that the confectionery product should melt in the mouth and that it should only have minor fractions of solids that melt above the blood temperature to yield a creamy mouth feel.

The hardness and the melting profile of a fat are linked to its degree of saturation. Highly saturated fats are usually solid or partially solid at ambient conditions, e.g. palm fat or any hydrogenated vegetable fat. Low levels of saturation yield a liquid product at ambient conditions, e.g. a sunflower oil.

In order to impart the required textural and sensorial properties to fat-based confectionery products, high SFA, solid type fats are used. Commonly used fats for fat-based confectionery products are hydrogenated coconut and palm kernel fats.

However, fats containing high amounts of saturated fatty acids (SFA) are known to have negative health benefits and are linked to an enhanced risk for cardiovascular diseases. In the recent years, this has led to an increasingly negative consumer perception of saturated fats.

Hydrogenation of oil is a commonly used technique to obtain solid type fats from liquid oils. Besides the resulting high SFA content, the presence of trans fatty acids in partially hydrogenated fats has become a severe health issue. Trans fatty acids are associated with cardiovascular diseases as well as with the risk of getting diabetes and some types of cancer such as breast cancer.

Hence it would be desirable to reduce or replace high SFA solid-type fats, or hydrogenated fats containing significant levels of trans fatty acids, by low SFA liquid oils. However, for persons skilled in the art it is evident that in most cases of solid confectionery products it is not possible to use a liquid oil instead of a solid fat. A difficulty in just increasing/replacing the solid fats with low SFA liquid oils is that this impacts on the physical properties such as the taste, texture and the overall appearance of the filling compositions (organoleptic parameters). Also the replacement of solid fats by low SFA liquid oils in the recipe can have a negative impact on processability, such as giving a much softer and stickier ingredient mixture, which can be unprocessable.

The consumer is not willing to compromise on the organoleptic properties of confectionery products, in order to decrease his SFA intake. Taste, texture and overall appearance are such organoleptic properties.

Obviously, industrial line efficiency is important in the food industry. This includes handling and processing of raw materials, forming of the confectionery products, packaging and later storing, in warehouses, on the shelf or at home.

It is an object of the present invention to provide confectionery products that have a reduced content of solid fats, a low SFA content, and that provide an excellent consumption experience to the consumer

It would be advantageous to provide confectionery products that are low in SFA, and that may be easily industrialised at a reasonable cost without compromising the organoleptic parameters.

### SUMMARY OF THE INVENTION

The inventors have developed a substantially different route to obtain new lipid based confectionery products.

It has surprisingly been found by the inventors that oil powders (encapsulated liquid oils) can be used to replace partially or completely the solid fats conventionally used in confectionery products.

Accordingly, in one aspect there is provided a confectionery product comprising agglomerated powder ingredients including an oil powder. The oil powder comprises an inner core comprising a liquid oil and an encapsulating outer shell comprising a cross-linked emulsifier.

The confectionery products of the invention have a firm or hard texture, and have a stable shape. The confectionery products advantageously have a creamy and pleasant mouthfeel. The present invention makes it possible to provide confectionery products which are low in SFA by the use of liquid vegetable oils.

In another aspect there is provided the use of an oil powder for the preparation of a solid confectionery product.

In a further aspect the invention relates to a process for preparing a confectionery product according to the present invention, comprising:
providing an oil powder;
mixing the oil powder with other powder ingredients and any optional non-powder ingredient(s);
compacting or shaping the obtained mixture by pressure agglomeration; and,
optionally applying a coating to the thus obtained solid confectionary mass.

The compacting or shaping of the powder ingredients is carried out by a pressure agglomeration technique, advantageously by an extrusion process or a powder compaction technique.

### DETAILED DESCRIPTION OF THE INVENTION

The inventors of the present invention have surprisingly found that confectionery products with a stable shape and good organoleptic properties such as a smooth indulgent texture can be manufactured by pressure agglomeration of powder ingredients including an oil powder.

Accordingly, in one aspect the invention relates a confectionery product comprising agglomerated powder ingredients including an oil powder.

The confectionery products of the invention have a firm or hard texture, and have a stable shape. The confectionery products advantageously have a creamy and pleasant mouthfeel. The present invention makes it possible to provide confectionery products which are low in SFA by the use of liquid vegetable oils.

Several advantages of the confectionery product according to the invention may exist, including:
I. The replacement, partially or totally, of solid fats with oil powder
II. The provision of a confectionery product low in SFA, whilst having good shape retension and organoleptic parameters;
III. The confectionery products of the invention can advantageously have a low density, due to entrapped air;
IV. A creamy and pleasant mouthfeel due to the release of encapsulated oil in the mouth
V. An Additional advantage may be in the ease of product handling;
VI. Also in the range of different product shapes, forms, concepts realizable on the basis of the different pressure agglomeration techniques.
VII. Shape retention of the confectionery product on exposure to heat, due to the heat stability of the encapsulated oil.

The oil powder comprises an inner core comprising a liquid oil and an outer shell comprising a cross-linked emulsifier.

Any type of known oil powder that is solid at room temperature is suitable to be used according to the present invention given that the oil content is high enough to provide the desired creamy and pleasant mouthfeel. The liquid oil content of the oil powder is at least 40% w/w, such as from 40 to 99.5% w/w. Preferably the oil powder comprises at least 60% w/w, more preferably at least 70% w/w, more preferably at least 80% w/w, more preferably at least 90% w/w oil, such as at least 95% w/w, or even at least 99% w/w oil. For instance, in one embodiment the oil powder contains from 70% to 99.5% w/w oil. In a preferred embodiment the oil powder comprises from 90% to 99.5% w/w, such as from 90% to 99% w/w oil. Above 99.5% w/w oil content the oil powder can start to lose its solid state properties.

The oil powder can be obtained by known emulsion-based encapsulation processes. These processes have in common that they are based on an oil-in-water emulsion that is dried to obtain an oil powder. The drying step can be carried out by any commonly known drying technique such as air drying, ventilation, spray drying, vacuum drying, freeze drying, etc. Prior to the drying step a step to crosslink the emulsifier can be included. Suitably this may be effected by a heat treatment, a chemical treatment or an enzymatic treatment to crosslink the used emulsifier, e.g. milk proteins. The final oil powder usually consists of a liquid vegetable oil that is encapsulated in a matrix material consisting of proteins, carbohydrates, or other surface active agents, or mixtures thereof.

The oil used for preparing the emulsion can be any vegetable oil or fat that is liquid or that can be liquefied at ambient conditions. The oil can comprise mineral oils and/or organic oils (oils produced by plants or animals), in particular food grade oils. Examples include sunflower oil, rapeseed oil, olive oil, soy oil, fish oil, linseed oil, safflower oil, corn oil, algae oil, cottonseed oil, grape seed oil, nut oils such as hazelnut oil, walnut oil, rice bran oil, sesame oil, peanut oil, palm oil, palm kernel oil, coconut oil, or combinations thereof. Optionally, the oil can contain one or more liposoluble compound; such as for example plant polyphenols, fatty acids, such as n-3 fatty acids, n-6 fatty acids, vitamins, aromas, antioxidants, other active ingredients. Preferably, an oil with a low SFA content is chosen such as high oleic sunflower oil or high oleic rapeseed oil.

The emulsifier may be a protein, carbohydrate, other surface active agent, or mixtures thereof. Preferably the emulsifier used is a protein-based emulsifier. The protein that is used to encapsulate the oil to produce the oil powder can be any food-grade protein such as milk and/or whey proteins, soy proteins, pea proteins, caseinate, egg albumen, lyzozyme, gluten, rice protein, corn protein, potato protein, pea protein, skimmed milk proteins or any kind of globular and random coil proteins as well as combinations thereof. In one preferred embodiment the protein is one or more milk and/or whey derived protein.

Preferred milk proteins or milk protein fractions in accordance with the present invention comprise, for example, whey proteins, α-lactalbumin, β-lactalbumin, bovine serum albumin, acid casein, caseinates, α-casein, β-casein.

As far as whey proteins are concerned, the protein source may be based on acid whey or sweet whey or mixtures thereof and may include α-lactalbumin and β-lactalbumin in any proportions. The proteins may be intact or at least partially hydrolysed.

Typically the oil powder comprises up to about 30% w/w of the encapsulating protein, preferably up to about 20% w/w protein, more preferably up to about 10% w/w protein, more preferably up to about 5% w/w protein. In one preferred embodiment the oil powder comprises a maximum of 1% w/w of the protein.

The single particles of oil powder according to the invention typically have an average particle diameter in the range of form about 0.1 to 100 μm, for example about 1 to 50 μm.

The proteins may optionally comprise food grade salts, such as sodium citrate, magnesium citrate, potassium citrate or combinations thereof. Such salts may be present in an amount typically up to 10% w/w, preferably from 0 to 5% w/w.

Emulsion based processes to obtain oil powders are known and suitable oil powders are commercially available. Suitable such oil powders can be prepared according to known processes, for instance, such as described in EP 1 998 627, WO2010/057852, WO2008/066380.

According to one embodiment the oil powder may be prepared by an emulsion based process, comprising preparing an emulsion of the oil, the emulsifier (preferably a protein), and optionally a food grade salt and/or a liposoluble compound; crosslinking the protein, for example by heating, UV-radiation, chemically or enzymatically; spray-drying the emulsion to generate the oil powder. According to one embodiment an oil powder as described in WO2010/057852 is used.

The solid confectionery product according to the invention may typically comprise about 5% to 70% w/w, preferably from about 5 to 60% w/w, preferably from about to 50% w/w, such as from about 10 to 50% w/w, of the oil powder.

Fat based solid confectionery products typically comprise from about 5 to 70% (w/w) solid fats, typically from about 15 to 55% (w/w), such as from about 20-50% (w/w) solid fats.

Typical solid fats include coconut oil, palm kernel oil, palm oil, cocoa butter, butter oil, lard, tallow, oil/fat fractions such as lauric or stearic fractions, hydrogenated oils, and blends thereof.

In the preparation of the confectionery product of the present invention oil powders are used partially or totally in place of the usual partially solid fats used in the preparation of solid fat-based confectionery products. Typical solid fat replacement ratios are from about 1% to 100%, preferably from about 15% to 100%, preferably from about 15% to 100%, more preferably about 15-75%, more preferably about 25-60%. Preferred replacement ratios depend amongst others on the desired texture and other organoleptic properties of the confectionery product. Higher replacement ratios can in some cases lead to products with a more sticky texture. At very high, near 100%, replacement ratios there can, in some cases be some leakage of the oil from the oil powder, which can be less desirable for certain applications.

One beneficial feature of the present invention is the flexibility of the approach in terms of ingredients. The present invention is not related to particular fat fractions or crystallizing agents. In the present invention any type of oil with a desired degree of saturation can be used. In doing so, a reduction in SFA content of up to about 80% compared to a confectionery product based on conventional solid fats can be obtained, for instance, fat-based confectionery products with a SFA content as low as that of a high oleic sunflower oil (about 8% w/w SFA) can be obtained.

Preferably the other powder ingredients of the confectionery product according to the invention include a sugar and/or cocoa powder.

Sugars include sucrose, dextrose, fructose and lactose, preferably sucrose.

In some embodiments the confectionery product comprises an amount of sugar of about 10 to 70% w/w, preferably from about 20 to 70% w/w, such as from about to 65% w/w, such as from about 45 to 55% w/w sugar.

In some embodiments the confectionery product contains cocoa powder in an amount from 1 to 80% w/w, preferably from about 5 to 70% w/w, such as from about 5 to 50% w/w, from about 5 to 40% w/w, from about 10 to 30% w/w, for instance around 10 to 20% w/w cocoa powder.

The confectionery product according to the invention may comprise other common ingredients of a fat-based confectionery, such as, for example, skimmed milk powder, full cream milk powder, whey powder, yoghurt powder, fruit acids, natural or synthetic flavors, natural or artificial colors, starch based fillers, fibres, nut powders, emulsifiers such as lecithin.

According to some embodiments a confectionery product according to the invention may comprise from 0 to 65% w/w of a solid fat, from about 5 to 70% w/w of oil powder, and from about 10 to 70% w/w of sugar.

According to some embodiments a confectionery product according to the invention may further comprise from about 5 to 70% w/w of cocoa powder, and about 2 to 20% w/w of milk powder.

The present invention further provides a process for the preparation of the confectionery products of the present invention. Said process involves the pressure agglomeration of the oil powder ingredient along with other ingredients of the solid confectionery product mass.

Accordingly, in one aspect the invention relates to a process for preparing a confectionery product according to the present invention, comprising:
providing an oil powder;
mixing the oil powder with other powder ingredients and any optional non-powder ingredient(s);
compacting or shaping the obtained mixture by pressure agglomeration; and,
optionally applying a coating to the thus obtained solid confectionary mass.

The term pressure agglomeration refers to the application of pressure to particles of the powder ingredients (otherwise referred to as primary particles) in order to cause agglomeration. Without wishing to be bound by any particular theory it is understood that under the application of significant pressure on the powder matrix, the primary particles are deformed and increased Van der Waals and electrostatic forces are created between the particles. This leads to the formation of bridges/interlocking between the particles, and is accompanied by a growing contact number, decreased porosity and particle breakage, thereby contributing to the formation of agglomerates.

The compacting or shaping of the powder ingredients is carried out by a pressure agglomeration technique. Pressure agglomeration processes/techniques refer to techniques in which primary particles are exposed to a significant pressure in order to form agglomerates. Typical pressure agglomeration processes include extrusion, roller compaction and tableting process.

The process of the invention is not limited to any particular pressure agglomeration technique, and any known pressure agglomeration technique is contemplated. Suitably the compacting or shaping of the powder ingredients is carried out by an extrusion process or a powder compaction technique, such as roller compaction or tabletting/mould-punch processes.

Conventional extrusion, roller compaction or tabletting techniques can be applied and are well-known in the field.

Extrusion of powder masses is typically applied for the agglomeration of food additives and various other food powders like instant beverages, cereals or snack products. Generally extrusion processes involve pressing an ingredient mix through a perforated die in an extruder by a piston or an agitator. Also screw extruders exist, in which a screw transports the product that is subsequently forced through a die with a defined shape. Interparticle friction in the die entry region and wall friction in the die lead to a pressure build-up which ensures the formation of stable agglomerates. Typically, the resulting product strand emerging from the extruder is subsequently cut or broken into single agglomerates. These can be dried, for instance, in a fluid bed or an oven until they reach their final water content.

Generally, roller compaction techniques generate irregularly shaped compacts of relatively high density, and roller compaction is commonly used for the agglomeration of high molecular carbohydrates or e.g. seasoning powders. In a typical roller-compaction process two counter-rotating rollers put high pressure on a continuous powder stream moving through the gap between them. An adjustment of the applied pressure is possible by changing the gap width between the rollers or variation of the feeding rate. After the compaction, the ribbons obtained from the initial powder may be first ground, e.g. by toothed crushers, and the agglomerates with the desired size can then be obtained from a subsequent sieving process.

Tableting processes are generally used for the production of seasoning and confectionery tablets in different sizes and shapes. Food powders can be compacted directly or after an additional agglomeration step, which facilitates the compaction process and enhances the flowability of the powder. The actual tableting process generally involves the filling of a constant mass of powder into dies, followed by pre-compressing it for at least partial air release as well as particle rearrangement and a final pressure or distance controlled compression leading to particle breakage and deformation. After the pressure is released, the tablets re-expand elastically and are released by ejection. Conventional devices for tableting in the food industry include eccentric tablet presses or more commonly used rotary tablet presses, such as double-punch type rotary presses.

In a preferred embodiment the pressure agglomeration is carried out by an extrusion process or a tabletting/mould press process. Advantageously these techniques are simple, cost effective, and easily applied on an industrial scale.

Advantageously the present invention provides an easier route to making solid confectionery products, such as praline type products, than the conventional processes based on liquid methods, which involve a number of steps involving heating (e.g. using heating tanks), moulding, cooling, de-moulding.

The shape and other physical properties, such as density, porosity, hardness, of the produced confectionery product can be adjusted dependent on the process used.

For example, in the case of tableting, pre-dosed quantities can be pressed into distinctive shapes with defined dimensions, defined by the shape of the mould. The resulting confectionery products have low density due to entrapped air, which contributes to a pleasant melting mouthfeel upon consumption. The resultant confectionery products can have a very firm or hard texture and have a highly stable shape, with a high resistance to deformation. The produced confectionery products are particularly easy to handle and pack.

For instance extrusion processes can be advantageous for the preparation of bar, stick or pillow type shaped products. In extrusion processes it is possible to include some ingredients in non-powder form, such as liquid ingredients. For instance a liquid oil may be added in the extruder, or a fat which is semi-solid or solid at room temperature can be added to the extruder after heating to liquefy the fat. The addition of other fats in this way can allow the formation of more malleable products.

The pressure agglomeration of the powder ingredients including the used oil powder confers a stable shape and firm or hard texture to the confectionery product. Upon mechanical stress in the mouth and upon contact with the saliva the oil powder releases its oil in the mouth, hereby imitating a melting event.

Optionally the solid confectionery product mass, produced by the pressure agglomeration, may be coated, with a confectionery coating, preferably sugar-based coating or a fat-based coating (such as, chocolate, a chocolate compound or chocolate flavoured coating or other fat-based coating). Any known confectionery coating is contemplated. Conventional coatings techniques can be used to apply the coating to the confectionery product. Advantageously, the good shape stability of the products of the invention make it easy to apply a coating using conventional techniques.

The confectionery products of the invention have a firm texture, and have a stable shape, with defined dimensions. Advantageously confectionery products of the invention are resistant to substantial deformation on handling, and are easy to handle and pack. Advantageously confectionery products of the invention exhibit good shape retention properties on exposure to heat. For example confectionery products according to the invention can retain their shape on exposure to heat above room temperature, above warm temperatures such as 30° C. Confectionery products according to the invention can retain their shape on heating to 40° C., and even on heating up to 60° C.

The confectionery products of the invention advantageously have a smooth, creamy and pleasant mouthfeel.

The confectionery products of the invention advantageously have a high porosity, which allows the provision of confectionery products having a lower total fat content, compared to conventional fat-based confectionery products such as praline type confections, and contributes to providing a smooth, light texture in the mouth on consumption.

The present invention makes it possible to provide confectionery products that are low in SFA, whilst having good shape retention and organoleptic properties.

It should be noted that embodiments and features described in the context of one of the aspects or embodiments of the present invention also apply to the other aspects of the invention.

All patent and non-patent references cited in the present application, are hereby incorporated by reference in their entirety.

The invention will now be described in further details in the following non-limiting examples.

### EXAMPLES

### Example 1

### Preparation of an Oil Powder

An oil powder was prepared according to WO2010/057852.

### (i) Emulsion Preparation:

Sunflower oil was emulsified in an aqueous solution of WPI (whey protein isolate, 1% (w/w) or 3% (W/W)). The final emulsion contained 20% (w/w) of sunflower oil. The emulsification was carried out with a high pressure homogenizer. The parameters were adapted to reach an oil droplet size between 0.5 microns and 5 microns.

### (ii) Thermal Crosslinking:

The emulsion was heat treated at 80° C. for 10 min to achieve a cross-linking of the protein layer which surrounds the oil droplets in the emulsion. The crosslinked emulsion was subsequently cooled to ambient temperature.

(iii) Spray Drying Process:

The emulsion was spray dried in a Niro SD-6.3-N pilot plant spray dryer. The following parameters were used: atomization by a spraying disc, throughput 10 l/h, inlet temperature 105° C., outlet temperature 65° C. The obtained oil powders had a moisture content of less than 0.5% (w/w).

### Example 2

### Preparation of a Confectionery Product

Recipe (Amounts Given as % w/w):

TABLE 1

| | | 50% | 100% |
|---|---|---|---|
| | Comparative | oil powder | oil powder |
| Solid vegetable fat | 30 | 15 | 0 |
| Sugar | 50 | 50 | 50 |
| lecithin | 0.5 | 0.5 | 0.5 |
| milk powder | 4.5 | 4.5 | 4.5 |
| oil powder | 0 | 15 | 30 |
| cocoa powder | 15 | 15 | 15 |

The oil powder was prepared according to the method in example 1. Confectionery products were then prepared by pressure agglomeration of the ingredients by (i) extrusion (Example 3); (ii) tabletting (Example 4).

### Example 3

### Preparation of Confectionary Product by Extrusion

The powder ingredients (table 1) were dry mixed and then the mixture was fed into the twin screw extruder (Clextral Evolum 25). Extrusion was carried out under the following conditions: mass flow rate 10 kg/h, the rotational speed of the screws 100 rpm, outlet temperature 16° C. The resulting extrudate was then cut using a standard cutter to achieve single portions of 10 g and dimensions 15 mm in diameter and 50 mm in length.

If desired a coating, such as a sugar coating, chocolate coating, or other fat-based coating can be applied to the confectionery product after cutting.

The obtained products were tested for heat stability and porosity:

### (i) Shape Stability on Exposure to Heat.

Confectionery products obtained according to the invention prepared by the extrusion process of example 2, following the recipes with 50% and 100% replacement of vegetable fat by the oil powder (3% whey protein isolate) of example 1 were tested for heat stability. The samples were stored at 40° C. and at 60° C. for 1 hour. Shape stability was then tested by application of a load of 90 g on the product and observing any change in dimensions. After 1 hour storage at 40° C. and 60° C. no deformation was observed for the products according to the invention with 50% ratio of fat replacement by the solid oil powder. For the products with 100% replacement of fat by the oil powder, slight deformation was observed upon application of the load after heat treatment.

The results clearly demonstrate good retention of shape of the confectionery products according to the invention on exposure to heat.

### (ii) Porosity:

Porosity of confectionery products and according to the invention with 50% and 100% replacement of fats with the oil powder was analysed, together with that of a non-extruded reference example prepared according to the comparative conventional recipe. Porosity was measured by X-ray tomography (ScancoMedical) and mass density measurements. Results are shown in table 2.

TABLE 2

| Sample | Porosity (%) |
|---|---|
| 50% oil powder | 17.74 |
| 100% oil powder | 17.34 |
| Comparative reference | 2.0 |

Thus, based on these results it is seen that the confectionery products of the invention advantageously have a high porosity.

### Example 4

### Preparation of Confectionery Product by Tableting

The powder ingredients (table 1) were dry mixed and then the mixture was filled into the mould of the tablet press (mould diameter 20 mm, 4 g of mixture per mould). The powder was then compressed at different compacting forces from 50 N to 4000 N. Holding times between 300 and 1000 milliseconds and a compaction speed of 1 m m/s were applied. The resulting confectionery product was de-moulded.

If desired a coating, such as a sugar coating, chocolate coating, or other fat-based coating can be applied to the confectionery product after de-moulding.

The obtained products were tested for shape stability and porosity.

Shape stability was tested by measurement of tablet hardness and tensile strength.

(i) Hardness of the confectionery products was measured with a Standard commercial tablet hardness tester (TBH1000 from ERWEKA), using compaction forces of 32N, 181 N, 182N
(ii) Compressive strength was measured by a compression test carried out with a Zwick Roell Z005 material tester (Germany) equipped with a 5 kN load cell at a punch velocity of 0.1 mm/s. The test comprises the application of load on top of a cylindrical tablet in upright position, and measures induced compressive stress, whereby the compressive strength σₜ of the tested tablet with the height H and the diameter D can be calculated from the maximum compressive force F acting on the cross-sectional area of the tablet according to the following equation:

$${σ}_{c} = \frac{Force}{Area}$$

The measured compressive forces are shown in Table 3.

(iii) Porosity was measured by X-ray tomography (ScancoMedical).

Results are shown in table 3

| | Tabletting | | | | | |
|---|---|---|---|---|---|---|
| Sample | compressive | | | | | |
| Recipe | force | stability | diameter | mass | height | porosity |
| Comparative | 610N | 181N, | 20 mm | 4 g | 10.8 mm | 4.4% |
| recipe | | OK | | | | |
| 50% SolidOil, | 610N | OK | 20 mm | 4 g | 10.8 mm | 4.4% |
| 1% WPI | | | | | | |
| 50% SolidOil, | 50N | 32N, | 20 mm | 4 g | 11.5 mm | 4.4% |
| 1% WPI | | slightly | | | | |
| | | fragile | | | | |
| 50% SolidOil, | 610N | 182N, | 20 mm | 4 g | 11.5 mm | 10.2% |
| 3% WPI | | OK | | | | |
| 50% SolidOil, | 200N | OK | 20 mm | 4 g | — | — |
| 3% WPI | | | | | | |
| 50% SolidOil, | 400N | OK | 20 mm | 4 g | — | — |
| 3% WPI | | | | | | |
| 50% SolidOil, | 600N | OK | 20 mm | 4 g | — | — |
| 3% WPI | | | | | | |
| 50% SolidOil, | 1000N | OK | 20 mm | 4 g | — | — |
| 3% WPI | | | | | | |
| 50% SolidOil, | 4000N | deoiling | 20 mm | 4 g | — | — |
| 3% WPI | | | | | | |

The results show that at tablet compaction forces up to 1000 N no deoiling of the oil powder is observed. Compaction forces of as low as 50 N allowed to prepare solid products with reasonable shape stability. Good porosity of the produced confectionery products are observed, higher than porosities for a conventional confectionery product prepared by conventional methods, ie. not by the tableting process. The compression test show that the tablets have good stable shape but are not too hard, thus ensuring that the indulgent mouthfeel of the confectionary product is not compromised.

1. A solid confectionery product comprising pressure agglomerated powder ingredients, the powder ingredients comprise an oil powder.

2. A solid confectionery product according to claim 1 wherein the oil powder comprises an inner core comprising an oil and an outer shell comprising a cross-linked emulsifier, and the oil powder comprises at least 40% w/w oil.

3. A solid confectionery product according to claim 1 wherein the oil powder comprises at least 90% oil.

4. A solid confectionery product according to claim 1 wherein the oil is selected from the group consisting of olive oil, safflower oil, sunflower oil, fish oil, soy bean oil, soy oil, palm kernel oil, palm oil, coconut oil, flaxseed oil, rapeseed oil, primrose oil, linseed oil, corn oil, cottonseed oil, essential oils, animal oil, mineral oils, organic oil and combinations thereof.

5. A solid confectionery product according to claim 1 wherein the cross-linked emulsifier is a cross-linked protein.

6. A solid confectionery product according to claim 1 wherein the protein comprises at least one food-grade protein.

7. A solid confectionery product according to claim 1, wherein the oil powder has an average particle size of about 0.1-100 μm.

8. A confectionery product according to claim 1 wherein the pressure agglomerated powder ingredients comprise an ingredient selected from the group consisting of a sugar, cocoa powder, milk powder, and combinations thereof.

9. A confectionery product according to claim 1 wherein the oil powder comprises from 5% to 70% w/w of the total ingredients.

10. A confectionery product according to claim 1, comprising from 0 to 65% w/w of a solid fat, from 5 to 70% w/w of oil powder, and from 10 to 70% w/w of sugar.

11. A confectionery product according to claim 1 comprising from 5 to 70% w/w of cocoa powder, and 2 to 20% w/w of milk powder.

12. A confectionery product according to claim 1 comprising a coating.

13. A method for the preparation of a solid confectionery product comprising pressure agglomerating oil powder with other powder ingredients of the confectionery product.

14. The method according to claim 15 wherein the powder ingredients comprise an ingredient selected from the group consisting of a sugar, cocoa powder, milk powder, and combinations thereof.

15. A process for the preparation of a solid confectionery product comprising the steps of: providing an oil powder; mixing the oil powder with other powder ingredients; compacting or shaping the obtained mixture by pressure agglomeration; and, applying a coating to the solid confectionery mass.

16. A process according to claim 15 wherein the pressure agglomeration is performed by a powder compaction technique.

17. A process according to claim 15 wherein the pressure agglomeration is performed by an extrusion process.

18. A solid confectionery product according to claim 1 wherein the protein comprises a food-grade protein selected from the group consisting of whey protein, caseinate, egg albumen, lyzozyme, soy proteins, gluten, rice proteins, corn proteins, potato proteins, and pea proteins.

19. A process for the preparation of a solid confectionery product comprising the steps of: providing an oil powder; mixing the oil powder with other powder ingredients; and compacting or shaping the obtained mixture by pressure agglomeration.
